(19) United States
(12) Patent Application Publication
(10) Pub. No.: US 2007/0286016 A1
(43) Pub. Date: Dec. 13, 2007

(54) Automatic stirring and rotating cup holder

(75) Inventor: De-Hong Sun, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Jie-Yi Co., Ltd.

(21) Appl. No.: 11/448,092

(22) Filed: Jun. 7, 2006

(51) Int. Cl. B01F 7/00

(52) U.S. Cl. 366/279

(57) ABSTRACT

An automatic stirring and rotating cup holder comprises a stand, a power mechanism and a stirring device, wherein the stand has a disk for holding a cup and a coupling part for coupling with the power mechanism. A transmission is mounted inside the stand, wherein the disk is rotated by the transmission. Several control keys are mounted on the power mechanism, and the stirring device is mounted on the power mechanism for performing a stirring process corresponding to the movement of the disk. Accordingly, the solution inside the cup can be mixed adequately for drinking the solution easily and increasing the visual enjoyment.

### FIELD OF THE INVENTION

The present invention relates to a convenient automatic stirring and rotating cup holder that provides the spice of life and is suitable for holding a cup or the like so as to stir or mix various beverages contained in the cup.

### BACKGROUND OF THE INVENTION

The container such as cup or bow is for containing food. Particularly, the cup is for containing liquid beverage such as coffee solution. After the addition of milk and sugar into the coffee solution, the coffee solution is always stirred by using spoon or muddler for dissolving them completely, thereby providing the coffee drinker with pleasure and satisfaction.

However, the phenomenon of deposition occurred if the coffee solution is placed immovably for a period of time. Therefore, the coffee solution must be stirred again by using the spoon or the muddler for mixing the coffee solution fully and providing the coffee solution with a more uniform temperature distribution. As a result, the best mouthfeel can be provided for the drinker.

The coffee cup or disk is merely placed on the desk surface and has no interaction with the drinker when the drinker is alone. As a result, the coffee drinking process is very boring for the drinker. Besides, the drinker rotates conventional spoon or muddler by himself/herself in a routine and boring manner. If the drinker is taking to other people face to face or making a phone call, he/she always drinks the coffee directly without stirring the coffee again, causing solid-liquid separation to the coffee. Accordingly, the best flavor of the coffee cannot be expressed.

Whereas the foregoing description, the present inventor makes diligent studies in providing the consumers with an easily operable automatic stirring and rotating cup holder.

### SUMMARY OF THE INVENTION

It is a main object of the present invention to provide an automatic stirring and rotating cup holder that increases the visual enjoyment and the spice of life.

It is another object of the present invention to provide an easily operable automatic stirring and rotating cup holder.

In order to achieve the above-mentioned objects, an automatic stirring and rotating cup holder comprises a stand, a power mechanism and a stirring device, wherein the stand has a disk for holding a cup and a coupling part for coupling with the power mechanism. A transmission is mounted inside the stand, wherein the disk is rotated by the transmission. Several control keys are mounted on the power mechanism, and the stirring device is mounted on the power mechanism for performing a stirring process corresponding to the movement of the disk. Accordingly, the solution contained inside the cup can be mixed adequately for drinking the solution easily and increasing the visual enjoyment.

The aforementioned objects and advantages of the present invention will be readily clarified in the description of the preferred embodiments and the enclosed drawings of the present invention.

### BRIEF DESCRIPTION OF THE DRAWINGS

FIG. 1 is a three-dimensional view showing a first preferred embodiment of the present invention.

FIG. 2 is a cross-sectional view showing the first preferred embodiment of the present invention.

FIG. 3 is an exploded view showing the components of the first preferred embodiment of the present invention.

FIG. 4 is a three-dimensional view showing a second preferred embodiment of the present invention.

FIG. 5 is a three-dimensional view snowing a third preferred embodiment of the present invention.

FIG. 6 is a three-dimensional view showing another application of the third preferred embodiment of the present invention.

### DETAILED DESCRIPTION OF THE PREFERRED EMBODIMENT

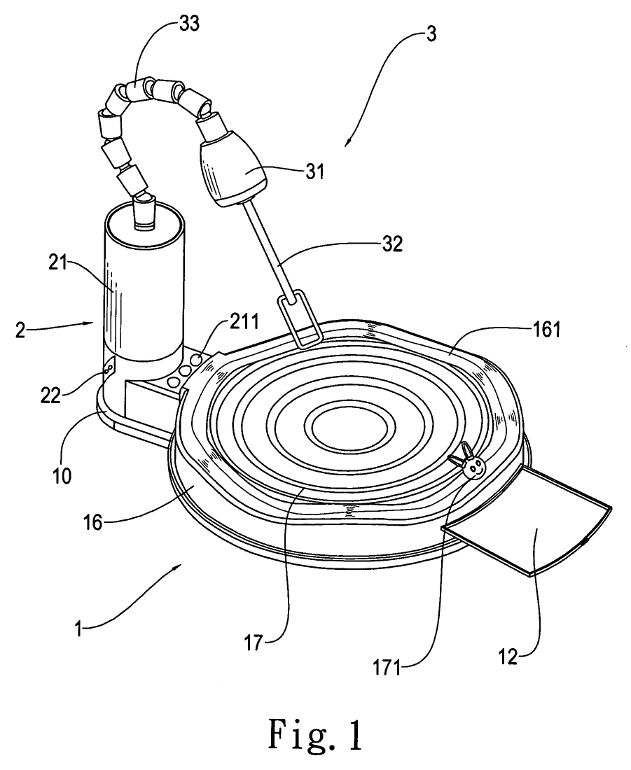

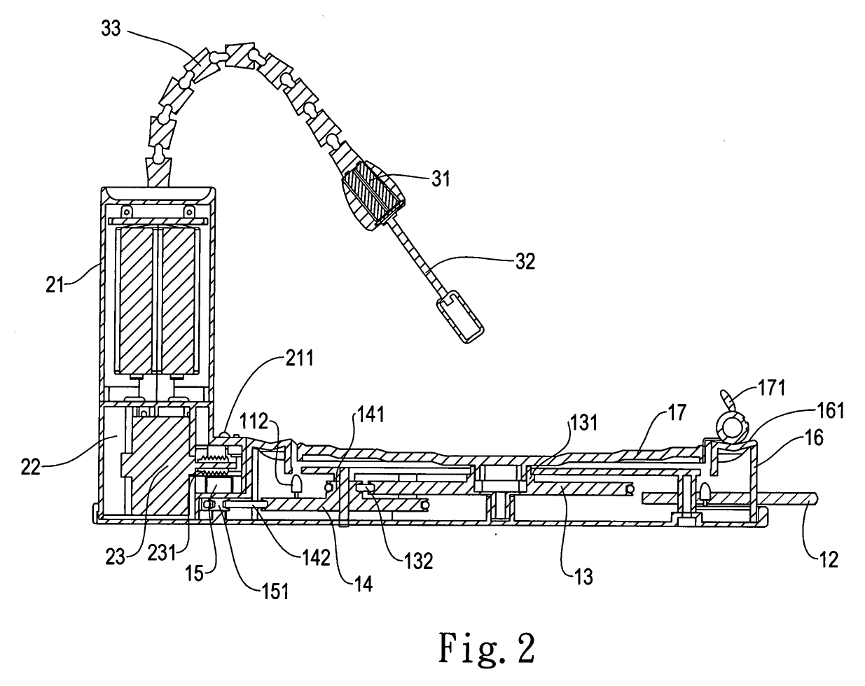

Referring simultaneously to FIG. 1 through FIG. 3, an automatic stirring and rotating cup holder comprises a stand 1, a power mechanism 2 and a stirring device 3, wherein the stand 1 is in the form of a plate. A coupling part 10 is protrudent from one side of the plate for coupling with the power mechanism 2, and a notch is formed on the other side of the plate. Two tracks 11 are extended from both sides of the notch, respectively. Two positioning pillars 111 are located inwardly on the respective bottoms of the tracks 11 for holding a drawer 12, wherein the drawer 12 has correspondingly located positioning recesses 121 and stoppers 122 and an inwardly located trench on one side. If the drawer 12 is shifted to the deepest inside, the drawer 12 is positioned by the positioning pillars 111 and the positioning recesses 121 to avoid sliding.

A transmission is mounted inside the stand 1. The transmission is composed of two pulleys 13 and 14 and two belts 132 and 142. Two grooves are formed on the respective outside of the pulleys 13 and 14 for holding the belts 132 and 142. Two synchronous transmission wheels 131 and 141 are mounted on the respective center portions of the pulleys 13 and 14. A buried trench is further formed on the synchronous transmission wheel 131, and the belt 132 is located to surround the pulley 13 and the synchronous transmission wheel 141 simultaneously. The belt 142 is located to surround the pulley 14 and a small pulley 151 driven by a reduction gear 15. The top of the plate is covered with a top cover 16 having a center hole and a wave-shaped protrudent part 161 on the edge. Several openings are formed on the intersection between the top cover 16 and the wave-shaped protrudent part 161 for holding several light-emitting diodes 112. Besides, a chute, which is slanted toward the center from both sides, is formed on the surface of the wave-shaped protrudent part 161. The synchronous transmission wheel 131 of the pulley 13 is inserted into and held by the center hole of the top cover 16. The synchronous transmission wheel 131 is coupled with a disk 17 by the buried trench such that the disk 17 and the pulley 13 are synchronously rotatable. A concentric stair-shaped trench is formed on the disk 17. Besides, a decoration 171, such as a rabbit-shaped decoration, is attached to the edge of the disk 17 in a location corresponding to the chute of the wave-shaped protrudent part 161 of the top cover 16. Two stoppers 162 are mounted on the top cover 16 in the locations corresponding to the stoppers 122 of the drawer 12 to avoid the deviation of drawer 12 from the tracks 11.

The power mechanism 2 has a battery chamber 21 for holding batteries, and a platform is formed on a lower portion of the power mechanism 2. Several control keys 211 are located on the platform. The stirring device 3 is mounted above the battery chamber 21, and an A/C socket 22 and a motor 23 are mounted under the battery chamber 21. A worm 231 is sleeved onto a motor shaft of the motor 23 and engaged with the reduction gear 15.

In the stirring device 3, a stirring rod 32 is connected to a motor shaft of a motor 31. The motor 31 is mounted on one end of a freely bendable tube 33, and the bendable tube 33 is composed of several short tubes and several ball-shaped connectors such that the bendable tube 33 can be adjusted to any angle. The other end of the bendable tube 33 is mounted above the battery chamber 21 of the power mechanism 2. The connection wires between the motor 31 and the power mechanism 2 may be embedded in the bendable tube 33.

When in a process for making coffee, for example, the drawer 12 of the stand 1 is pulled out for holding sugar, cream, etc. The cup 4, which is filled with the coffee solution, can be placed on the disk 17 of the stand 1 securely by properly locating the bottom of the cup 4 in the center of the concentric stair-shaped trench formed on the disk 17. After the addition of sugar and cream, the bendable tube 33 is bended to be suspended over the cup 4 for allowing the insertion of the stirring rod 32 into the cup 4. Thereafter, either the stirring rod 32 or the stand 1 may be rotated by controlling the control keys 211. In accordance with an optimum manner, the stirring device 3 is actuated first to allow the rotation of the stirring rod 32 by the motor 31. The coffee, sugar and cream in the cup 4 can be mixed with one another adequately for expressing the best flavor of coffee. Thereafter, the cup 4 is removed from the stand 1 for tasting the fragrant and rich coffee.

Thereafter, the stirring rod 32 may be inserted into the cup 4 by using the bendable tube 33, and the stand 1 is driven for rotation by controlling the control keys 21. In this condition, the motor 23 is actuated for driving the rotation of the reduction gear 15 by using the worm 231, which is engaged with the reduction gear 15 and sleeved onto the motor shaft, whereby the small pulley 151, which is connected to the bottom of the reduction gear 15, is rotated synchronously. Besides, the pulley 14 is interactively rotated by the small pulley 151 via the belt 142, and the pulley 13 is further interactively rotated by the pulley 14 via the synchronous transmission wheel 141 and the belt 132 for further rotating the disk 17, which is coupled with the synchronous transmission wheel 131. In addition, the light is emitted from the emitting diodes 112 to pass through the openings of the top cover 16. Besides, the small decoration 171 attached to the disk 17 can be shifted upward and downward with the wave-shaped protrudent part 161 by the rotation of the disk 17. Accordingly, the purpose of providing uniform mixing can be accomplished by rotating the disk 17 without the need to rotate the stirring rod 32 in the cup 4. Furthermore, the light-emitting manner of the light-emitting diodes 112 may be changed along with the passage of time so as to emit twinkling light, belt light, or delayed light, for example. In addition, the decoration 171 may be shifted by the rotation of the disk 17 for providing more interest in drinking drinks.

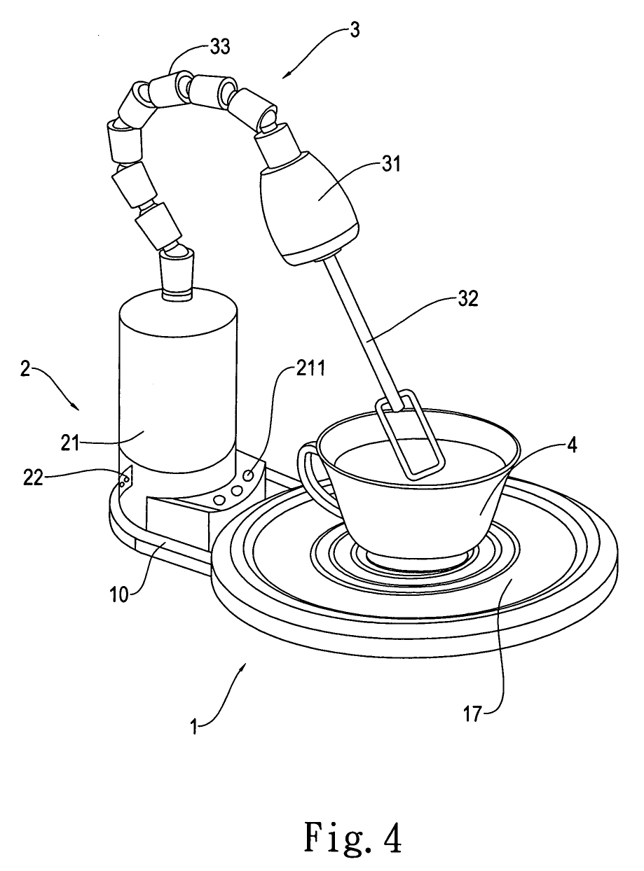

Referring to FIG. 4, a second preferred embodiment of the present invention is illustrated. The stand 1 is a solid stand on which a coupling part 10 and a concentric stair-shaped trench 18 are formed. The coupling part 10 is for holding a power mechanism 2 having a battery chamber 21 for holding batteries. A stirring device 3 is mounted above the battery chamber 21, and a stirring rod 32 is connected to a motor shaft of a motor 31. The motor 31 is mounted on one end of a freely bendable tube 33, and the bendable tube 33 is composed of several short tubes and several ball-shaped connectors such that the bendable tube 33 can be adjusted to any angle. The other end of the bendable tube 33 is mounted above the battery chamber 21 of the power mechanism 2. The connection wires between the motor 31 and the power mechanism 2 may be embedded in the bendable tube 33. An A/C socket 22 and a platform are located under the battery chamber 21. Several control keys 211 are located on the platform for controlling the rotational speeds of the motor 31.

When in use, the cup 4 is placed in the concentric stair-shaped trench 18 of the stand 1. The motor 31 is suspended over the cup 4 by adjusting the angle of the bendable tube 33 to allow the insertion of the stirring rod 32 into the cup 4 for stirring the solution inside the cup 4 adequately.

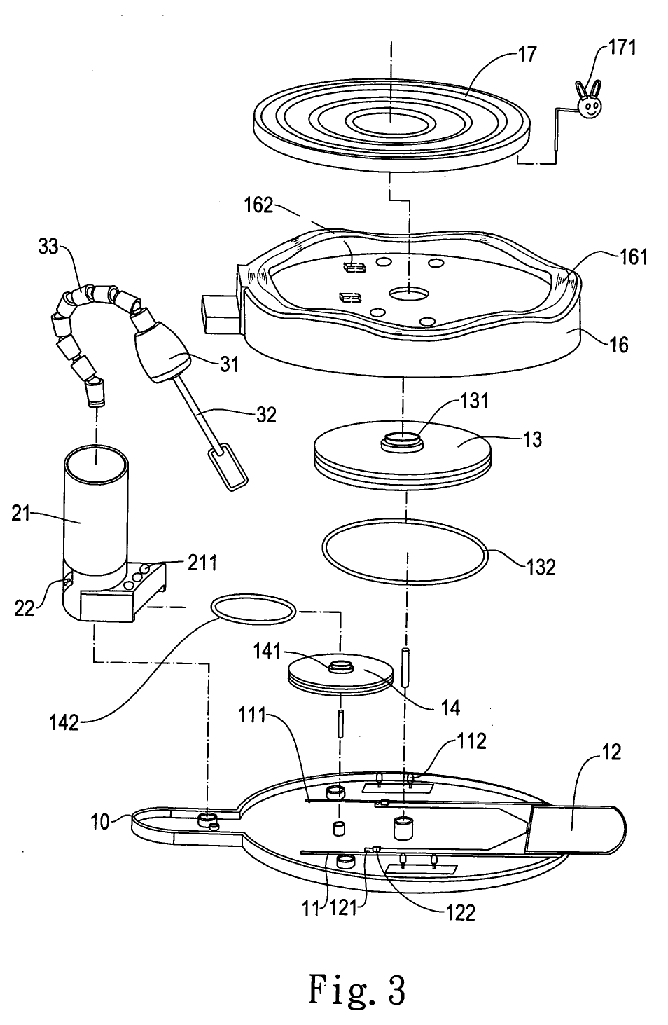

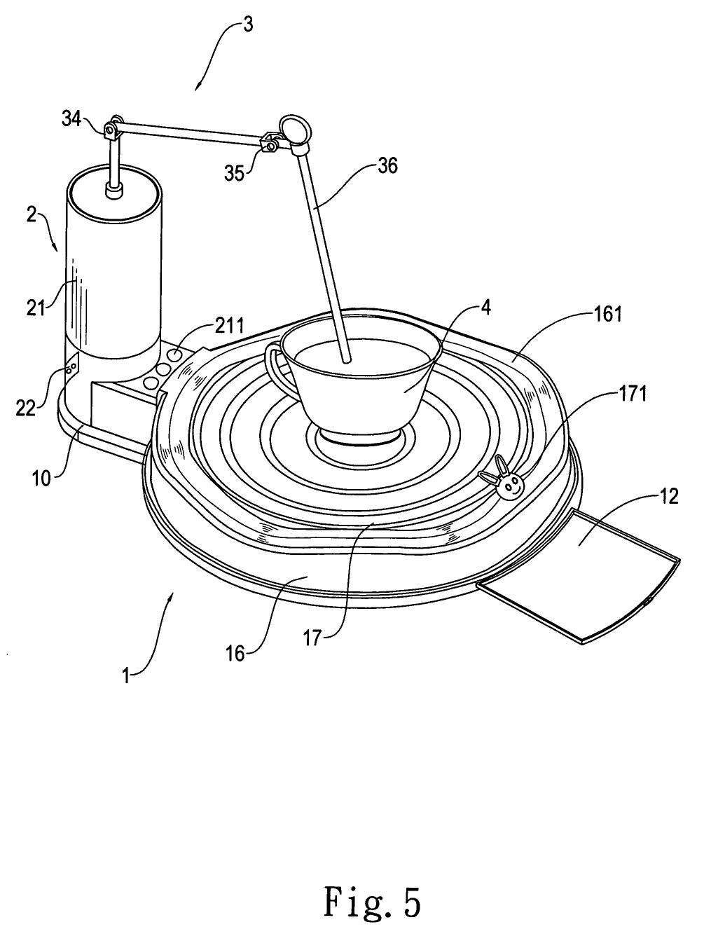

Referring to FIG. 5, a third preferred embodiment of the present invention is illustrated. In the third preferred embodiment, the stand 1 is identical to that of the first preferred embodiment. Referring to again FIG. 3, the stand 1 is in the form of a plate. A coupling part 10 is protrudent from one side of the plate for coupling with a power mechanism 2, and a notch is formed on the other side of the plate. Two tracks 11 are extended from both sides of the notch, respectively. Two positioning pillars 111 are located inwardly on the respective bottoms of the tracks 11 for holding a drawer 12, wherein the drawer 12 has correspondingly located positioning recesses 121 and stoppers 122 and an inwardly located trench on one side. Several light-emitting diodes 112 are located beside the tracks 11. A transmission is mounted inside the stand 1. The transmission is composed of two pulleys 13 and 14 and two belts 132 and 142. Two grooves are formed on the outside of the pulleys 13 and 14, respectively, for holding the belts 132 and 142. Two synchronous transmission wheels 131 and 141 are mounted on the respective center portions of the pulleys 13 and 14. A buried trench is further formed on the synchronous transmission wheel 131, and the belt 132 is located to surround the pulley 13 and the synchronous transmission wheel 141 simultaneously. The belt 142 is located to surround the pulley 14 and a small pulley 151 driven by a reduction gear 15. The top of the plate is covered with a top cover 16 having a center hole and a wave-shaped protrudent part 161 on the edge. Several openings are formed on the intersection between the top cover 16 and the wave-shaped protrudent part 161 for holding the light-emitting diodes 112. Moreover, a chute, which is slanted toward the center from both sides, is formed on the surface of the wave-shaped protrudent part 161. The synchronous transmission wheel 131 of the pulley 13 is inserted into and held by the center hole of the top cover 16. The synchronous transmission wheel 131 is coupled with a disk 17 by the buried trench such that the disk 17 and the pulley 13 are synchronously rotatable. A concentric stair-shaped trench is formed on the disk 17. A decoration 171, such as a rabbit-shaped decoration, is attached to the edge of the disk 17 in a location corresponding to the chute of the wave-shaped protrudent part 161 of the top cover 16. Two stoppers 162 are mounted on the top cover 16 in the locations corresponding to the stoppers 122 of the drawer 12 to avoid the deviation of drawer 12 from the tracks 11.

The power mechanism 2 has a battery chamber 21 for holding batteries, and a platform is formed on a lower portion of the power mechanism 2. Several control keys 211 are formed on the platform. An A/C socket 22 and a motor 23 are located under the battery chamber 21. A worm 231 is sleeved onto a motor shaft of the motor 23 and engaged with the reduction gear 15. A rod having a pivotal connection part 34 on the top thereof is mounted above the battery chamber 21, and the pivotal connection part 34 is pivotally connected to another rod having a pivotal connection part 35 on one end. A stirring rod 36 is further pivotally connected to the pivotal connection part 35. Alternatively, the rod having the pivotal connection part 35 on one end may be inclinedly connected to the power mechanism 2, and the stirring rod 36 may be further pivotally connected to the pivotal connection part 35.

When in use, the cup 4 is positioned on the disk 17 of the stand 1 securely by properly locating the bottom of the cup 4 in the center of the concentric stair-shaped trench formed on the disk 17. The stirring rod 36 can be pivotally rotated to a position above the cup 4 by using the pivotal connection parts 34 and 35 such that the bottom of the stirring rod 36 can be inserted into the cup 4. Thereafter, the disk 17 is rotated by controlling the control keys 211 for stirring the solution inside the cup 4. In addition, the small decoration 171 can be shifted upward and downward by the rotation of the disk 17. Furthermore, the light-emitting manner of the light-emitting diodes 112 may be changed along with the passage of time so as to emit twinkling light, belt light, or delayed light, for example, for providing more visual effect and interest.

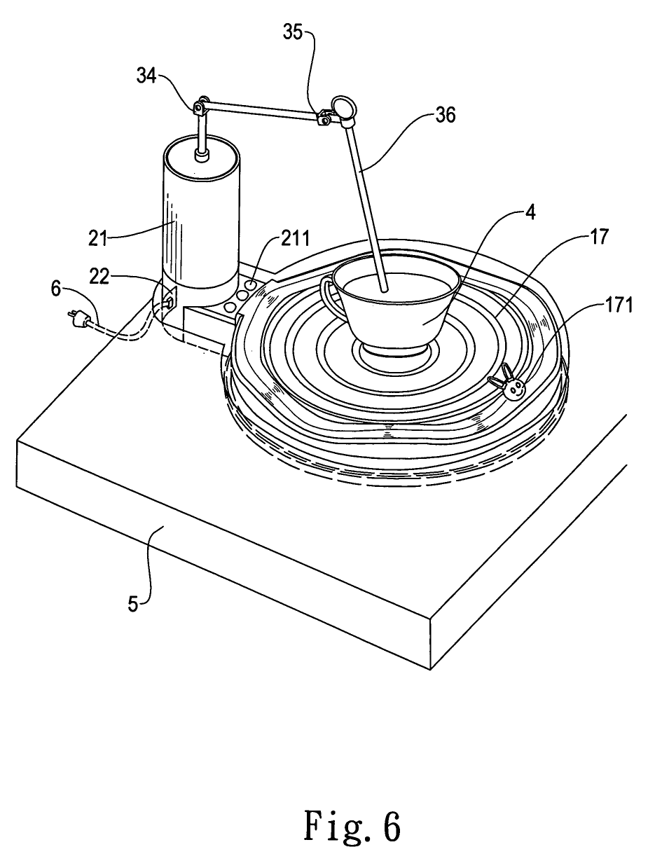

Referring further to FIG. 6, another application of the third preferred embodiment of the present invention is illustrated. The stand 1 is embedded into a table surface 5 such that the disk 17 of the stand 1 is coplanar with the table surface 5. The A/C socket 22 is coupled with an A/C plug 6. If the cup 4 is positioned on the disk 17, the stirring rod 36 can be pivotally rotated to a position above the cup 4 by using the pivotal connection parts 34 and 35 such that the bottom of the stirring rod 36 can be inserted into the cup 4. As a result, the disk 17 is rotatable, the small decoration 171 is shiftable and the light-emitting diode 12 can emit light by controlling the control keys 211 for providing more visual effect and interest and for evenly mixing the solution inside the cup 4.

In summary, the present invention indeed achieves the expected objects by disclosing the easily operatable automatic stirring and rotating cup holder. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. An automatic stirring and rotating cup holder comprising:
a stand having a disk for holding a cup and a transmission mounted therein for driving the rotation of said disk;
a power mechanism electrically connected to said stand for driving said transmission and having a plurality of control keys; and
a stirring device mounted on said power mechanism for performing a stirring process corresponding to the movement of said disk.

2. The automatic stirring and rotating cup holder of claim 1, wherein a concentric stair-shaped trench is formed on said disk.

3. The automatic stirring and rotating cup holder of claim 1, wherein said stand has a plate, a coupling part is protrudent from one side of said plate for coupling with said power mechanism, said transmission consisting of two pulleys are mounted beside said coupling part, two synchronous transmission wheels are mounted on respective center portions of said pulleys, two grooves are formed on the outside of said respective pulleys for holding respective belts, and said plate is covered with a top cover having a center hole, whereby one of said synchronous transmission wheels of one of said pulleys is inserted into and held by said center hole of said top cover so as to hold said disk.

4. The automatic stirring and rotating cup holder of claim 3, wherein two stoppers are mounted oppositely on the bottom of said top cover, a notch is formed on the other side of said plate, two tracks are extended from both sides of said notch, respectively, two positioning pillars are located inwardly on the respective bottoms of said tracks for holding a drawer having correspondingly located positioning recesses and stoppers and an inwardly located trench on one side thereof, whereby said stoppers can avoid the deviation of drawer from said tracks if said drawer is pulled outward from said plate and said top cover, which are coupled to each other.

5. The automatic stirring and rotating cup holder of claim 3, wherein a plurality of light-emitting diodes are mounted inside said plate and a plurality of openings are formed on said top cover corresponding to said light-emitting diodes.

6. The automatic stirring and rotating cup holder of claim 3, wherein a wave-shaped protrudent part is mounted on the edge of said top cover, said disk is interactively connected to and driven by said transmission via said center hole of said top cover, and a small decoration is attached to the edge of said disk, whereby said small decoration can be shifted upward and downward with said wave-shaped protrudent part.

7. The automatic stirring and rotating cup holder of claim 6, wherein a chute, which is slanted toward the center from both sides, is formed on a surface of said wave-shaped protrudent part.

8. The automatic stirring and rotating cup holder of claim 1, wherein said power mechanism has a battery chamber, an A/C power socket and a motor, and a worm is sleeved onto a motor shaft of said motor and engaged with a reduction gear having a small pulley mounted thereon.

9. The automatic stirring and rotating cup holder of claim 1, wherein said stirring device has a freely bendable tube, a motor and a stirring rod, wherein one end of said stirring rod is connected to a motor shaft of said motor, said motor is mounted on one end of said bendable tube, the other end of said bendable tube is connected to said power mechanism, and said bendable tube is composed of a plurality of ball-shaped connectors and a plurality of short tubes.

10. The automatic stirring and rotating cup holder of claim 1, wherein at least a rod is mounted on said stirring device, one end of said rod is connected to said power machine, the other end of said rod is connected to a pivotal connection part, which is pivotally connected to a stirring rod.
